(19) United States
(12) Patent Application Publication
(10) Pub. No.: US 2021/0152491 A1
(43) Pub. Date: May 20, 2021

(54) PRIORITIZATION AND INTELLIGENT ADJUSTMENT OF PRIORITY OF TUPLES

(71) Applicant: International Business Machines Corporation, Armonk, NY (US)

(72) Inventors: Jingdong SUN, Rochester, MN (US); Jessica R. EIDEM, Rochester, MN (US); Roger A. MITTELSTADT, Byron, MN (US); Rafal P. KONIK, Oronoco, MN (US)

(21) Appl. No.: 16/684,189

(22) Filed: Nov. 14, 2019

(51) Int. Cl. H04L 12/911; H04L 12/26; H04L 29/08

(52) U.S. Cl. CPC H04L 47/821; H04L 67/10; H04L 43/16

(57) ABSTRACT

Techniques and apparatus for prioritizing tuples for processing in a distributed programming environment are provided. One technique includes identifying a plurality of tuples available for processing by an operator. At least a first set of the plurality of tuples are processed according to a first type of priority. In response to detecting that a set of conditions associated with processing the plurality of tuples according to a second type of priority are satisfied, at least a second set of the plurality of tuples are processed according to the second type of priority.

### BACKGROUND

The present invention relates to streaming applications, and more specifically, to prioritizing streaming data based on operator attributes and stream data attributes.

A stream, or streams, application typically has large amounts of data flowing through an arrangement of processing elements, as specified by an operator graph. In a stream application, a sequence of data elements (e.g., tuples) flow into the stream application via a source operator from various sources such as electronic sensors, files, or the output of another data source. The source operator processes each data element according to the logic of that operator. Once processed, the data is sent to the next operator(s) of the stream application for additional processing as per the logic specified in the respective operator.

For real-time data stream computing (e.g., in a cloud-based platform), many of the operations used by various streaming applications may be similar and shared by a same operator. In such cases, a stream operator may be responsible for processing streaming data from multiple different data sources and/or going to different destinations. Typically, stream operators process tuples in real-time on a first come, first serve basis. However, this prioritization may not be ideal for situations in which an operator is processing tuples from different sources and/or with different attributes. For example, in situations where an operator is operating with limited resources, the operator may have to prioritize between multiple tuples stored within a buffer. Accordingly, it may be desirable to provide techniques that enable stream operators to prioritize processing of tuples in situations when the operator is processing tuples from different sources and/or with different attributes.

### SUMMARY

According to one embodiment, a computer-implemented method generally includes identifying, at a first operator, a plurality of tuples available for processing by the first operator. The method also includes processing, at the first operator, at least a first set of the plurality of tuples according to a first type of priority. The method further includes upon detecting, by the first operator, that a set of conditions associated with processing the plurality of tuples according to a second type of priority are satisfied, processing, at the first operator, at least a second set of the plurality of tuples according to the second type of priority.

According to another embodiment, a system includes a computing device having a processor, and a memory containing a program, which when executed by the processor, performs an operation. The operation generally includes identifying a plurality of tuples available for processing by the computing device. The operation also includes processing at least a first set of the plurality of tuples according to a first type of priority. The operation further includes upon detecting that a second set of conditions associated with processing the plurality of tuples according to a second type of priority are satisfied, processing at least a second set of the plurality of tuples according to the second type of priority.

According to yet another embodiment, a computer program product comprising a computer-readable storage medium having computer-readable program code embodied therewith is provided. The computer-readable program code is executable by one or more computer processors to perform an operation. The operation generally includes identifying, at a first operator, a plurality of tuples available for processing by the first operator. The operation also includes processing, at the first operator, at least a first set of the plurality of tuples according to a first type of priority. The operation further includes upon detecting, by the first operator, that a set of conditions associated with processing the plurality of tuples according to a second type of priority are satisfied, processing, at the first operator, at least a second set of the plurality of tuples according to the second type of priority.

The following descriptions and the related drawings set forth in detail certain illustrative features of one or more embodiments.

### BRIEF DESCRIPTION OF THE SEVERAL VIEWS OF THE DRAWINGS

FIG. 1 illustrates a computing infrastructure configured to execute a stream computing application, according to one embodiment.

FIG. 2 illustrates an example operator graph, according to one embodiment.

FIG. 3 is a flowchart of a method for prioritizing tuples for processing in a distributed programming environment, according to one embodiment.

FIG. 4 is a flowchart of a method for adjusting priority of tuples for processing in a distributed programming environment, according to one embodiment.

FIG. 5 is a flowchart of a method for determining whether to adjust a priority of a tuple, according to one embodiment.

FIG. 6 is a flowchart of another method for determining whether to adjust a priority of a tuple, according to one embodiment.

FIG. 7 illustrates an example computing system with a prioritization component, according to one embodiment.

FIG. 8 illustrates an example computing system with a prioritization manager, according to one embodiment.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Embodiments described herein provide methods, processing systems, and computer-readable mediums for prioritizing tuples in one or more streams of data for processing by a stream operator. In one embodiment, the stream operator can receive multiple tuples with various different attributes. For example, the tuples may have different sources, different sinks (or destinations), different sizes, and so on. According to one embodiment described herein, a stream operator may prioritize tuples in real-time according a first type of prioritization (e.g., first come, first serve basis). For example, the stream operator may prioritize tuples according to the first type of prioritization when detecting that an amount of resources (e.g., processors, memory, network bandwidth, etc.) is above a threshold, determining that a predefined trigger (or event) is not present in the system, etc.

Upon detecting a set of conditions associated with implementing a second type of prioritization that is different from the first type of prioritization, the stream operator may prioritize tuples in real-time according to the second type of prioritization. The set of conditions may include, for example, detecting that an amount of resources is below a threshold, detecting the occurrence of a predefined trigger (or event) within the system, detecting that there are multiple tuples (e.g., a number of tuples that satisfies a threshold number of tuples) waiting to be processed (e.g., there is a backlog), etc. The second type of prioritization may be based on one or more tuple attributes. In one embodiment, for example, the second type of prioritization may be a source driven priority (e.g., the type of source the tuple is received from). In another embodiment, the second type of prioritization may be a sink driven priority (e.g., the destination that the tuple is going to). In yet another embodiment, the second type of prioritization may be an environment-driven priority (e.g., the type of environment that in which the tuple is associated with). In a further embodiment, the second type of prioritization may be a system-driven priority (e.g., an expected amount of resources that will be used by the tuple). In yet a further embodiment, the second type of prioritization may be a user-driven priority (e.g., the user specifies which tuples should be processed first). In general, the second type of prioritization may be based on any combination of attributes of a tuple (e.g., source and sink attributes, etc.).

In some embodiments, a stream operator can adjust the prioritization of tuples when certain conditions (for adjusting the priority) are satisfied. For example, assume a tuple has a priority of “10” on a priority scale of “1” to “10” where “1” is the highest priority and “10” is the lowest priority. In this example, if the stream operator determines that the amount of time that the tuple has been idle (e.g., waiting to be processed) is greater than a threshold amount of time, the stream operator can adjust the priority of the tuple to a higher priority setting (e.g., “9” or higher). In some cases, each priority level may be associated with a different threshold amount of time. For example, priority level “10” may have a higher threshold amount of time than priority level “9”, priority level “8,” and so on. The stream operator may continue to adjust the priority of a given tuple (when the tuple satisfies certain conditions) until the tuple is processed. Note, however, that the above priority scale is merely an example, and that other priority scales and designations of “high” and “low” priority can be used.

In another embodiment, the condition(s) may be based on detection of a trigger (or event) in the system. For example, continuing with the above scale, a tuple may have a current priority of “5” based on its destination (e.g., retail store). In this example, if the retail store encounters an emergency (e.g., fire alarm, natural disaster, etc.), the stream operator may dynamically adjust the priority of the tuple to a higher priority setting (e.g., “1” or “2”), based on detection of the emergency. In some cases, after adjusting the priority of the tuple based on detection of the trigger, the stream operator can continue the adjustment based on another condition (e.g., time-based, another type of event detected, etc.). In this manner, embodiments provide techniques that enable stream operators to efficiently process tuples in different system environments.

Although the following describes a distributed application of a streams processing environment as a reference example of an application executing in a cluster of computing nodes, where processing elements in each node perform some tasks that result in data being output to other processing elements, one of skill in the art will recognize that embodiments presented herein may be adapted to a variety of applications having processing elements that perform tasks and that can be deployed on compute nodes in a dynamic manner.

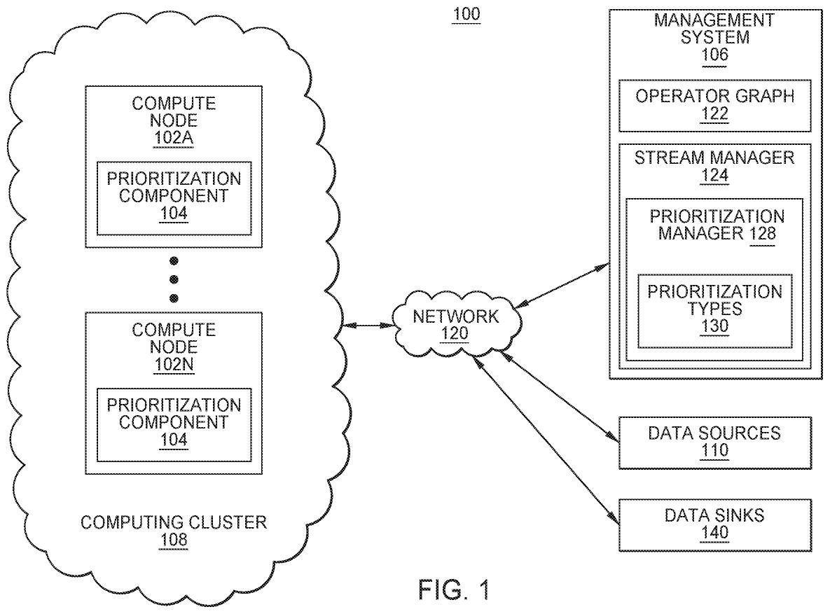

FIG. 1 illustrates a computing infrastructure 100 configured to execute a stream computing application, according to one embodiment. As shown, the computing infrastructure 100 includes a computing cluster 108 with a number of compute nodes 102A-N, a management system 106, and one or more communication data sources 110, which communicate via a network 120 (e.g., a local area network (LAN) or the Internet).

In a stream computing application, operators are connected to one another such that data flows from one operator to the next (e.g., over a TCP/IP socket). Scalability is achieved by distributing an application across nodes by creating executables, also referred to herein as processing elements (PEs), as well as deploying the PEs on multiple nodes and load balancing among them. By default, each operator in a stream computing application may execute as a single PE. Multiple operators (or PEs) can also be fused together to form a single PE that is executable. When operators (or PEs) are fused together in a PE, the fused operators can use more rapid communication techniques for passing data than the inter-process communication techniques (e.g., a TCP/IP socket) that would otherwise be used. Further, PEs can be inserted or removed dynamically from an operator graph representing the flow of data through the stream computing application.

In the depicted embodiment, each of the compute nodes 102A-N—i.e., hosts—may be a physical computing system or a virtual computing instance executing in, e.g., a cloud computing environment. Although compute nodes 102A-N are shown for illustrative purposes, a computing cluster may generally include any number of compute nodes. The compute nodes 102A-N are configured to execute PEs of a distributed stream computing application which retrieves input streams of data from various data sources 110, e.g., over the network 120 and analyzes the input streams in manageable data units called “tuples.” The input streams may be destined to one or more data sinks 140. The data sources 110 may include, but are not limited to, sensors, input/output devices, data feeds (e.g., from web logs), etc. The data streams may include, but are not limited to, text data, video data, and audio data. Examples of retrieved data include message data, Extensible Markup Language (XML) documents, biometric data captured from individuals in real time, emergency (“911”) calls, etc.

Each tuple of data may include a list of attributes, and the PEs of a stream computing application executing on various compute nodes may each performs task(s) using a tuple as input and output another tuple that may itself be input into a subsequent PE. That is, each PE may execute as an independent process on a compute node, and tuples flow from PE to PE in the streams processing environment. The compute nodes 102A-N may be communicatively coupled to each other using one or more communication devices that use a particular communication protocol (e.g., TCP/IP) to transfer data between the compute nodes 102A-N. In addition, the compute nodes 102A-N may transfer data internally between PEs located on the same compute node 102. Although not shown, code of a stream computing application may also include configuration information specifying properties of the streams processing environment, such as properties describing on which compute node a given processing element is located, a specified flow of data between processing elements, address information of each node, identifiers for processing elements, prioritization information, and the like.

Each compute node 102A-N includes a prioritization component 104, which is configured to perform prioritization of tuples received by the prioritization component 104, e.g., before processing the tuples. The prioritization component 104 can be configured to perform prioritization based on one or more tuple attributes, user defined configuration, system attributes, etc. For example, the prioritization component 104 may prioritize tuples based on a user defined configuration, the source of the tuples, the destination of the tuples, the size of the tuples, the type of system in which the compute node 102 is located in, the current state of the operating environment, and/or any combination thereof.

The management system 106 may be a physical computing system or a virtual machine instance running in, e.g., a cloud environment. As shown, the management system 106 includes a stream manager 124 and an operator graph 122. The operator graph 122 represents a stream computing application beginning from one or more source operators through to one or more sink operators, as discussed in greater detail below. The flow from source operator(s) to sink operator(s) is also sometimes referred to as an execution path. The stream manager 124 may perform various functionalities, including deploying stream computing applications to, and monitor the running of those stream computing applications on, the compute nodes 102A-N.

As shown, the stream manager 124 includes a prioritization manager 128, which is generally responsible for managing the type of prioritization performed by the prioritization components 104. The prioritization manager 128, for example, may configure each of the prioritization components 104 with a particular prioritization type 130. In one embodiment, the prioritization manager 128 can configure each prioritization component 104 with a same prioritization type 130. In one embodiment, the prioritization manager 128 can configure one or more prioritization components 104 with different prioritization types 130. In some embodiments, the prioritization manager 128 may configure a given prioritization component 104 with a prioritization type 130, based on resources available to the compute node 102 associated with the prioritization component 104. For example, a prioritization component 104 on compute node 102A may be configured to prioritize tuples in a first come, first serve basis if a level of resources available to compute node 102A satisfies a (first) threshold, and a prioritization component 104 on compute node 102N may be configured to prioritize tuples based on the source of the tuples (or some other priority type 130) if a level of resources available to compute node 102N satisfies a (second) threshold.

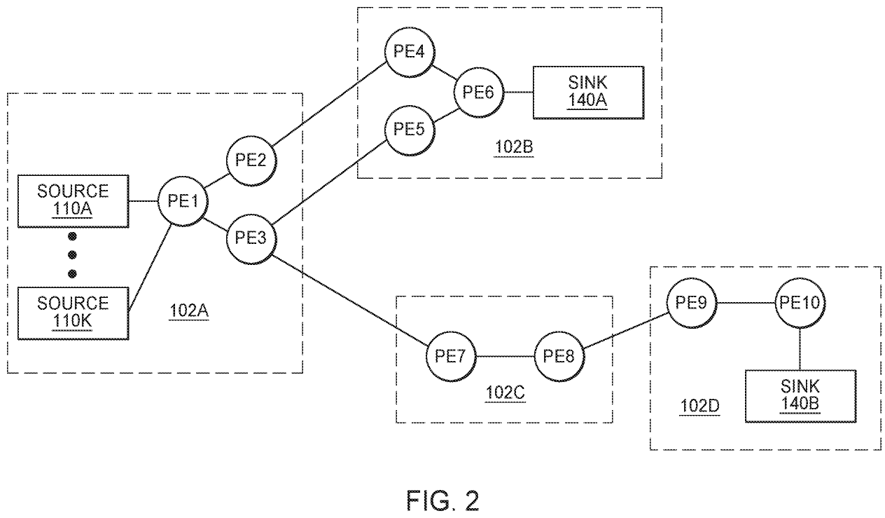

FIG. 2 illustrates an example operator graph that includes ten processing elements (labeled as PE1-PE10) running on the compute nodes 130A, 130B, 130C, and 130D. Each of the processing elements PE1-PE10 may prioritize tuples for processing using the techniques described herein. A PE is composed of one operator running as, or multiple operators fused together into, an independently running process with its own process ID (PID) and memory space. Although FIG. 2 is abstracted to show connected PEs, the operator graph 122 may include data flows between operators within the same PE or different PEs. Typically, PEs receive an N-tuple of data attributes from the stream as well as emit an N-tuple of data attributes into the stream (except for a sink operator where the stream terminates or a source operator where the stream begins). It should be noted that the N-tuple received by a PE need not be the same N-tuple sent downstream. Additionally, PEs may be configured to receive or emit tuples in other formats (e.g., the PEs or operators could exchange data marked up as XML documents). Furthermore, each operator within a PE may be configured to carry out any form of data processing functions on the received tuple, including, for example, writing to database tables or performing other database operations such as data joins, splits, reads, etc., as well as performing other data analytic functions or operations.

As shown, the operator graph begins at one or more sources 110A-K (that flow into PE1) and ends at sinks 140A and 140B (that flow from the PE6 and PE10, respectively). The compute nodes 140A includes PE1, PE2, and PE3. The sources 110A-K flow into PE1, which in turns emits tuples that are received by PE2 and PE3. In one example, PE1 may split data attributes received in a tuple and pass some data attributes to PE2, while passing other data attributes to PE3. Data that flows to PE2 is processed by the operators contained in PE2, and the resulting tuples are then emitted to PE4 on the compute node 102B. Likewise, the data tuples emitted by PE4 flow to the sink 140A via PE6. Similarly, data tuples flowing from PE3 to PE5 also reach the sink 140A via PE6. This example operator graph also shows data tuples flowing from PE3 to PE7 on the compute node 102C, which itself shows data tuples flowing to PE8. Data tuples emitted from PE8 flow to PE9 on the compute node 102D, which in turn emits tuples to be processed by sink 140B.

According to embodiments herein, each of the PEs 1-10 may prioritize tuples based on one or more conditions, prior to processing the tuples. Using PE1 as a reference example, as PE1 receives tuples from one or more of the sources 110A-K, PE1 may be configured to process tuples in real-time on a first come first serve basis (e.g., in cases where network throughput is above a threshold). When PE1 detects a set of conditions associated with switching to a different type of prioritization (e.g., network throughput is below a threshold), the PE1 may switch to prioritizing the tuples received from sources 110A-K, based on another type of prioritization. In one embodiment, PE1 may prioritize the tuples based on a type of the source 110. For example, the tuples from some sources 110A-B (e.g., hospital, police department, etc.) may be designated as higher priority compared to tuples from other sources 110C-D (e.g., office, retail store, school, etc.). In this example, when the set of conditions are detected, the PE1 may process tuples from sources 110A-B before tuples from sources C-D.

In another embodiment, when PE1 detects the set of conditions, PE1 may switch to prioritizing the tuples received from sources 110A-K, based on a type of destination (or sink 140). For example, a destination sink 140A (e.g., 911 call center) may have a higher priority than another destination sink 140B (e.g., customer support center). In this example, when the set of conditions are detected, the PE1 may process tuples destined to sink 140A prior to tuples destined to sink 140B.

In another embodiment, the PE1 can perform prioritization based on a user defined setting (e.g., PE1 can be configured to process tuples from source 110A before tuples from source 110B). In yet another embodiment, the PE1 can perform prioritization based on a type of environment. For example, a communication coming from a high ranking person (e.g., president, CEO, etc.) may have a higher priority than a communication coming from a lower ranking person (e.g., vice president, treasurer, etc.). In another example, a communication, which requests financial information related to a sale, may have higher priority when coming from a person that works in a financial department as opposed to another person that does not work in the financial department.

In yet another embodiment, the PE1 can perform prioritization based on a type of system (e.g., type of compute node 102A). For example, tuples that are expected to consume resources below a threshold may have a higher priority than other tuples that are expected to consume resources above the threshold. In general, however, the PE1 can perform prioritization based on any combination of the above.

Note that while PE1 depicted in FIG. 2 is used as a reference example of an operator that can use the prioritization techniques described herein, any of the PEs 2-10 (depicted in FIG. 2) can perform prioritization in a similar manner using the techniques described herein. Further, because a PE can include one or more (fused) operators, the operator graph can be described as execution paths between specific operators, which may include execution paths to different operators within the same processing element. For the sake of clarity, FIG. 2 illustrates execution paths between processing elements.

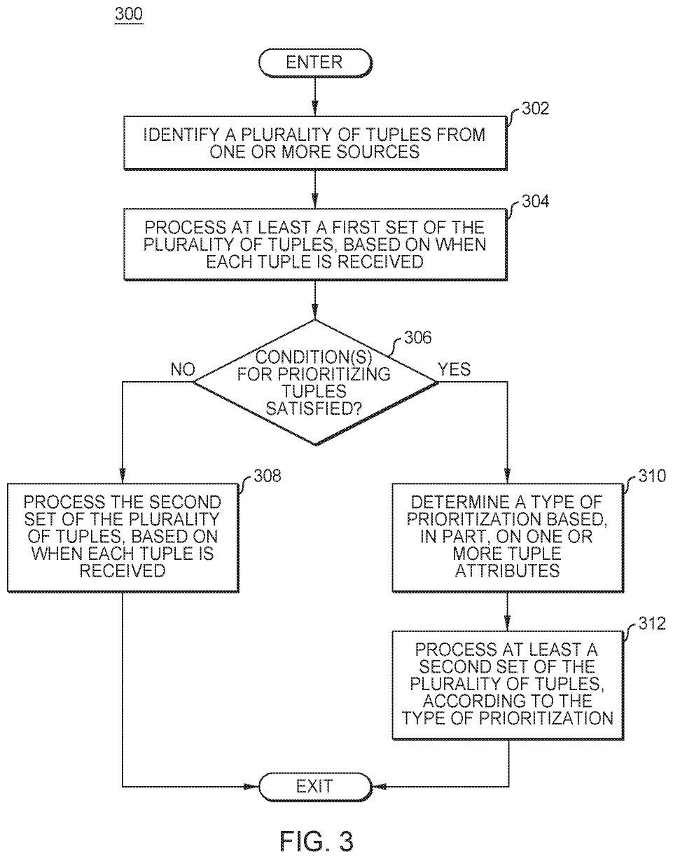

FIG. 3 is a flowchart of a method 300 for prioritizing tuples for processing in a distributed programming environment, according to one embodiment. The method 300 may be performed by a prioritization component (e.g., prioritization component 104).

Method 300 may enter at block 302, where the prioritization component identifies one or more tuples (belonging to one or more data streams) from one or more data sources. For example, the prioritization component can identify stock market data of real-time stock prices from a New York Stock Exchange data feed and a live video feed from the stock market floor of the London Stock Exchange.

At block 304, the prioritization component processes at least a first set of the plurality of tuples, based on when each tuple in the first set is received. That is, the prioritization component may process the tuples in the first set on a first come, first serve basis. For example, processing tuples on a first come, first serve basis may include determining that a first tuple is received by the prioritization component before a second tuple, transmitting the first tuple, and transmitting the second tuple after transmission of the first tuple. In some embodiments, the prioritization component may process tuples on a first come, first serve basis when the prioritization component determines that at least one of an amount of processors (or processor load) satisfies a threshold amount of processors (or threshold processor load), an amount of memory satisfies a threshold amount of memory, network bandwidth satisfies a threshold network bandwidth, etc.

At block 306, the prioritization component determines whether a set of conditions associated with prioritizing tuples (e.g., based on a different type of prioritization) are satisfied. For example, the prioritization component may determine that at least one of an amount of processors (or processor load) satisfies a threshold amount of processors (or threshold processor load), an amount of memory satisfies a threshold amount of memory, network bandwidth satisfies a threshold network bandwidth, etc. If the prioritization component determines the set of conditions are not satisfied at block 306, the prioritization component processes a second set of the plurality of tuples, based on when each tuple is received (block 308).

On the other hand, if the prioritization component determines the set of conditions are satisfied at block 306, the prioritization component determines a type of prioritization based, in part, on one or more attributes of the tuples (block 310). For example, in some cases, the prioritization component may determine to implement a static priority, where tuples of a certain type (e.g., “911” calls) are processed before tuples of another type (e.g., “non-911” calls). In other embodiments, the prioritization component may determine to implement a dynamic prioritization, based on the source of the tuples, the destination of the tuples, the size of the tuples, the type of system in which the compute node 102 is located in, the current state of the operating environment, and/or any combination thereof. In yet another embodiment, the prioritization component may determine to implement a prioritization based on a user defined configuration.

At block 312, the prioritization component processes tuples received at the prioritization component according to the determined type of prioritization. In one embodiment, processing tuples according to the type of prioritization may include determining that a first tuple has a higher priority than a second tuple, based on the type of prioritization, transmitting the first tuple, and transmitting the second tuple after transmission of the first tuple.

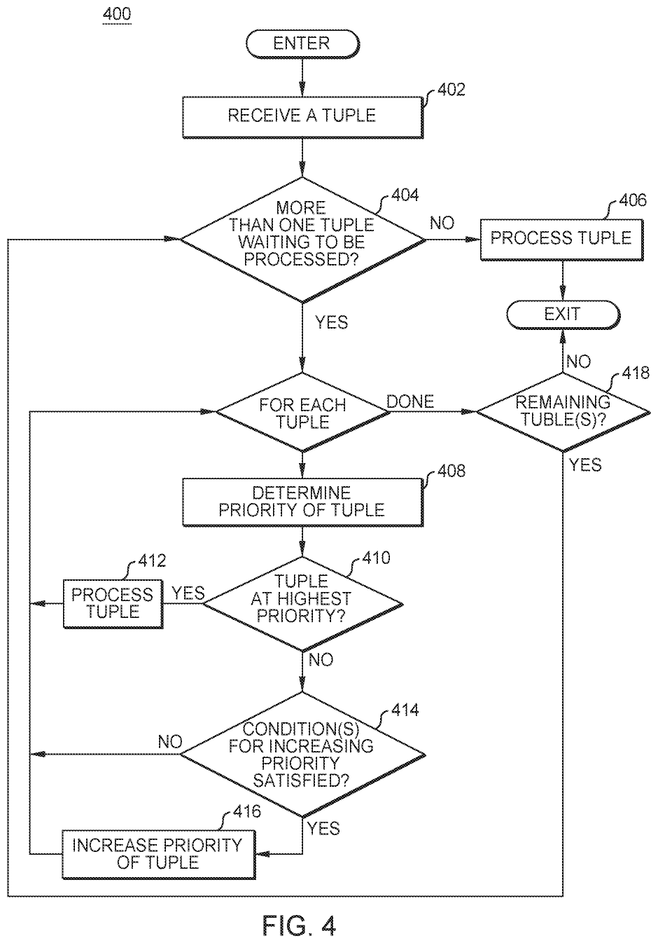

FIG. 4 is a flowchart of a method 400 for adjusting priority of tuples for processing in a distributed programming environment, according to one embodiment. The method 400 may be performed by a prioritization component (e.g., prioritization component 104).

Method 400 may enter at block 402, where the prioritization component receives (e.g., at a processing element) an incoming tuple. At block 404, the prioritization component determines whether there are multiple tuples waiting to be processed (e.g., at the processing element). If there are not multiple tuples waiting to be processed, the prioritization component processes the (incoming) tuple (block 406) and the method 400 exits. On the other hand, if there are multiple tuples waiting to be processed, the prioritization component, for each tuple waiting to be processed, determines at least the priority level of the tuple (block 408) and whether the tuple is at the highest priority level (block 410). If the prioritization component determines that a given tuple is at the highest priority level, then the prioritization component proceeds to process the tuple (block 412), and proceeds to perform blocks 408 and 410 for the next tuple (e.g., assuming there is a next tuple).

If the prioritization component determines that a given tuple is not at the highest priority level, then the prioritization component determines whether condition(s) for increasing the priority level of the tuple are satisfied (block 414). As described below, the conditions for increasing the priority level of the tuple can be based on an amount of time that the tuple has been waiting at a given priority level and/or whether an predefined event (associated with increasing the priority level of the tuple) is detected. If the prioritization component determines that the condition(s) for increasing the priority level of the tuple are not satisfied, the prioritization component proceeds to perform blocks 408 and 410 for the next tuple (e.g., assuming there is a next tuple). On the other hand, if the prioritization component determines that the condition(s) for increasing the priority level of the tuple are satisfied, the prioritization component increases the priority level of the tuple (block 416) and proceeds to perform blocks 408 and 410 for the next tuple (e.g., assuming there is a next tuple).

Once all tuples have been evaluated, the prioritization component determines if there are remaining tuple(s) waiting to be processed (block 418). If not, the method 400 exits. However, if there are remaining tuple(s) waiting to be processed, the prioritization component proceeds to block 404.

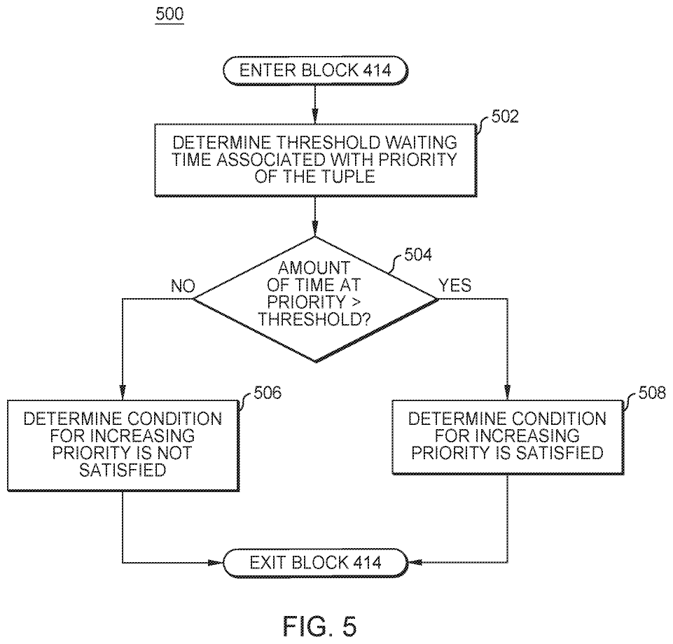

FIG. 5 is a flowchart of a method 500 for determining whether to adjust a priority of a tuple, according to one embodiment. The method 500 may be performed by a prioritization component (e.g., prioritization component 104). In one embodiment, the method 500 may be performed in order to implement the operation in block 414 of method 400 depicted in FIG. 4.

Method 500 may enter at block 502, where the prioritization component determines a threshold waiting time associated with the priority level of the tuple. At block 504, the prioritization component determines whether the amount of time the tuple has been waiting to be processed at the priority level is greater than the threshold waiting time associated with that priority level (block 506). If the amount of time is greater than the threshold waiting time, then the prioritization component determines that the condition for increasing the priority level of the tuple is satisfied (block 508). If the amount of time is not greater than the threshold waiting time, then the prioritization component determines that the condition for increasing the priority level of the tuple is not satisfied (block 506). The method 500 then exits.

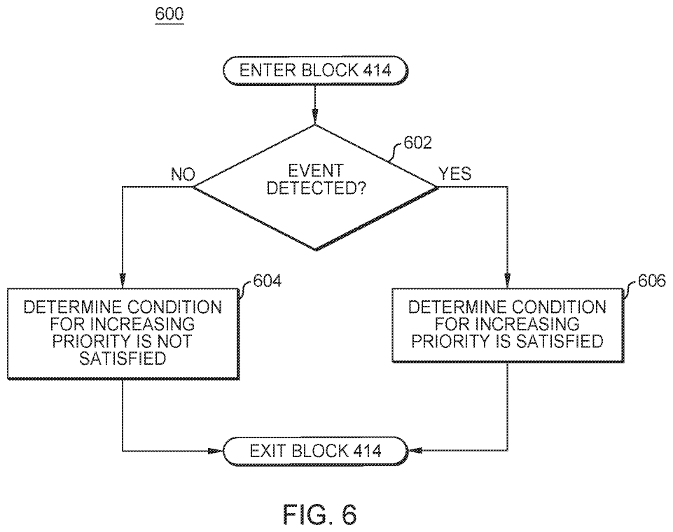

FIG. 6 is a flowchart of another method 600 for determining whether to adjust a priority of a tuple, according to one embodiment. The method 600 may be performed by a prioritization component (e.g., prioritization component 104). In one embodiment, the method 600 may be performed in order to implement the operation in block 414 of method 400 depicted in FIG. 4.

Method 600 may enter at block 602, where the prioritization component determines whether a predefined event has been detected. In one embodiment, the predefined event may be associated with one or more attributes of the tuple. For example, the prioritization component may detect (based on an indication received from the prioritization manager 128) that an emergency has occurred at a source of the tuple and/or destination of the tuple.

If the prioritization component detects occurrence of the event, then the prioritization component determines that the condition for increasing the priority level of the tuple is satisfied (block 606). If the prioritization component does not detect occurrence of the event, then the prioritization component determines that the condition for increasing the priority level of the tuple is not satisfied (block 604). The method 600 then exits.

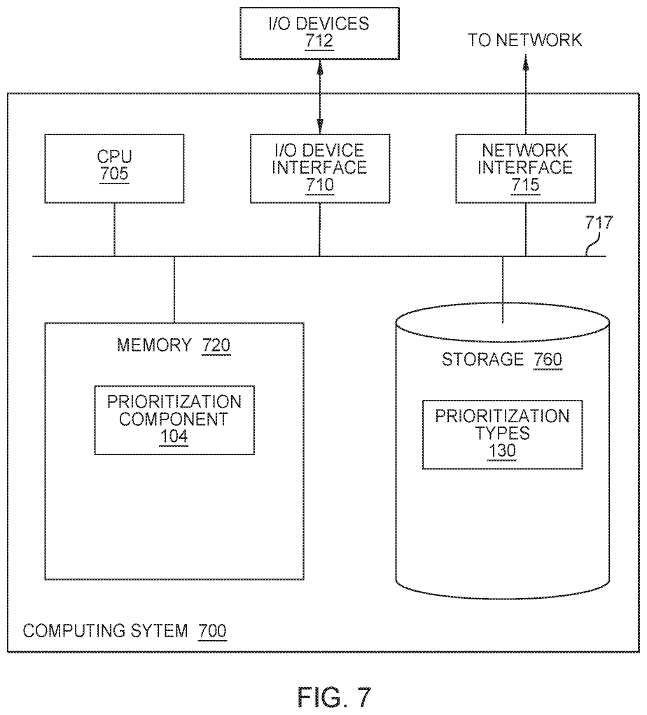

FIG. 7 illustrates a computing system 700 configured to perform prioritization of tuples for processing, according to one embodiment. As shown, the computing system 700 includes, without limitation, a central processing unit (CPU) 705, a network interface 715, a memory 720, and storage 760, each connected to a bus 717. The computing system 700 may also include an I/O device interface 710 connecting I/O devices 712 (e.g., keyboard, mouse, and display devices) to the computing system 700. Further, in context of this disclosure, the computing elements shown in the computing system 700 may correspond to a physical computing system (e.g., a system in a data center) or may be a virtual computing instance executing within a computing cloud.

The CPU 705 retrieves and executes programming instructions stored in the memory 720 as well as stores and retrieves application data residing in the memory 720. The interconnect 717 is used to transmit programming instructions and application data between CPU 705, I/O devices interface 710, storage 760, network interface 715, and memory 720. Note CPU 705 is included to be representative of a single CPU, multiple CPUs, a single CPU having multiple processing cores, and the like. Memory 720 is generally included to be representative of a random access memory. The storage 760 may be a disk drive storage device. Although shown as a single unit, storage 760 may be a combination of fixed and/or removable storage devices, such as fixed disc drives, removable memory cards, or optical storage, network attached storage (NAS), or a storage area-network (SAN). The storage 760 includes one or more prioritization types 130, which is described in more detail above. Illustratively, the memory 720 includes the prioritization component 104, which is described in more detail above.

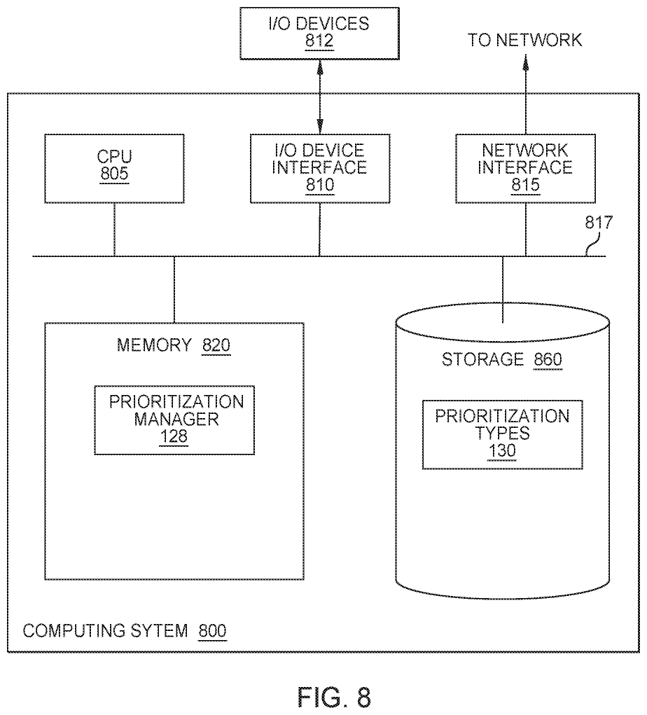

FIG. 8 illustrates a computing system 800 configured to manage non-persistent operator access to infrastructure components hosted in a cloud computing environment, according to one embodiment. As shown, the computing system 800 includes, without limitation, a central processing unit (CPU) 805, a network interface 815, a memory 820, and storage 860, each connected to a bus 817. The computing system 800 may also include an I/O device interface 810 connecting I/O devices 812 (e.g., keyboard, mouse, and display devices) to the computing system 800. Further, in context of this disclosure, the computing elements shown in the computing system 800 may correspond to a physical computing system (e.g., a system in a data center) or may be a virtual computing instance executing within a computing cloud.

The CPU 805 retrieves and executes programming instructions stored in the memory 820 as well as stores and retrieves application data residing in the memory 820. The interconnect 817 is used to transmit programming instructions and application data between CPU 805, I/O devices interface 810, storage 860, network interface 815, and memory 820. Note CPU 805 is included to be representative of a single CPU, multiple CPUs, a single CPU having multiple processing cores, and the like. Memory 820 is generally included to be representative of a random access memory. The storage 860 may be a disk drive storage device. Although shown as a single unit, storage 860 may be a combination of fixed and/or removable storage devices, such as fixed disc drives, removable memory cards, or optical storage, network attached storage (NAS), or a storage area-network (SAN). The storage 860 includes one or more prioritization types 130, which is described in more detail above. Illustratively, the memory 820 includes the prioritization manager 128, which is described in more detail above.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., prioritization component 104, prioritization manager 128, etc.) or related data available in the cloud. For example, the prioritization manager 128 could execute on a computing system in the cloud and configure one or more prioritization components 104 to perform prioritization of tuples according to one or more prioritization types 130. In such a case, the prioritization manager 128 could store information regarding the prioritization configuration of prioritization components 104 at a storage location in the cloud. Similarly, the prioritization component 104 could execute on a computing system in the cloud and perform prioritization of tuples for processing, e.g., by accessing prioritization configuration information at a storage location in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

What is claimed is:

1. A computer-implemented method comprising:
identifying, at a first operator, a plurality of tuples available for processing by the first operator;
processing, at the first operator, at least a first set of the plurality of tuples according to a first type of priority; and
upon detecting, by the first operator, that a set of conditions associated with processing the plurality of tuples according to a second type of priority are satisfied, processing, at the first operator, at least a second set of the plurality of tuples according to the second type of priority.

2. The computer-implemented method of claim 1, wherein processing the first set of the plurality of tuples comprises:
transmitting, according to the first type of priority, a first tuple of the first set of the plurality of tuples to a second operator; and
after transmitting the first tuple, transmitting, according to the first type of priority, a second tuple of the first set of the plurality of tuples to the second operator.

3. The computer-implemented method of claim 1, wherein processing the second set of the plurality of tuples comprises:
transmitting, according to the second type of priority, a first tuple of the second set of the plurality of tuples to a second operator; and
after transmitting the first tuple, transmitting, according to the second type of priority, a second tuple of the second set of the plurality of tuples to the second operator.

4. The computer-implemented method of claim 1, further comprising:
identifying, by the first operator, a first tuple of the plurality of tuples having a first priority level;
determining, by the first operator, a first amount of time that the first tuple has been waiting to be processed at the first priority level by the first operator; and
upon determining that the first amount of time satisfies a threshold amount of time associated with the first priority level, increasing, by the first operator, the priority of the first tuple to a second priority level.

5. The computer-implemented method of claim 4, further comprising:
determining, by the first operator, a second amount of time that the first tuple has been waiting to be processed at the second priority level by the first operator; and
upon determining that the second amount of time satisfies a threshold amount of time associated with the second priority level, increasing, by the first operator, the priority of the first tuple to a third priority level.

6. The computer-implemented method of claim 1, wherein the set of conditions comprises determining that an amount of resources at the first operator satisfies a threshold.

7. The computer-implemented method of claim 1, wherein the first type of priority is a first come, first serve prioritization.

8. The computer-implemented method of claim 1, wherein the second type of priority is based on at least one of a source of a tuple, a destination of a tuple, an amount of available resources at the first operator, and a current state of an environment in which the first operator is located.

9. A system, comprising:
a computing device having a processor; and
a memory containing a program, which when executed by the processor, performs an operation comprising:
identifying a plurality of tuples available for processing by the computing device;
processing at least a first set of the plurality of tuples according to a first type of priority; and
upon detecting that a set of conditions associated with processing the plurality of tuples according to a second type of prioritization are satisfied, processing at least a second set of the plurality of tuples according to the second type of priority.

10. The system of claim 9, wherein processing the first set of the plurality of tuples comprises:
transmitting, according to the first type of priority, a first tuple of the first set of the plurality of tuples to another computing device; and
after transmitting the first tuple, transmitting, according to the first type of priority, a second tuple of the first set of the plurality of tuples to the other computing device.

11. The system of claim 9, wherein processing the second set of the plurality of tuples comprises:
transmitting, according to the second type of priority, a first tuple of the second set of the plurality of tuples to another computing device; and
after transmitting the first tuple, transmitting, according to the second type of priority, a second tuple of the second set of the plurality of tuples to the other computing device.

12. The system of claim 9, the operation further comprising:
identifying a first tuple of the plurality of tuples having a first priority level;
determining a first amount of time that the first tuple has been waiting to be processed at the first priority level by the computing device; and
upon determining that the first amount of time satisfies a threshold amount of time associated with the first priority level, increasing the priority of the first tuple to a second priority level.

13. The system of claim 12, the operation further comprising:
determining a second amount of time that the first tuple has been waiting to be processed at the second priority level by the computing device; and
upon determining that the second amount of time satisfies a threshold amount of time associated with the second priority level, increasing the priority of the first tuple to a third priority level.

14. The system of claim 9, wherein the set of conditions comprises determining that an amount of resources at the computing device satisfies a second threshold.

15. The system of claim 9, wherein the first type of priority is a first come, first serve prioritization.

16. The system of claim 9, wherein the second type of priority is based on at least one of a source of a tuple, a destination of a tuple, an amount of available resources at the computing device, and a current state of an environment in which the computing device is located.

17. A computer program product comprising a computer-readable storage medium having computer-readable program code embodied therewith, the computer-readable program code executable by one or more computer processors to perform an operation, the operation comprising:
identifying, at a first operator, a plurality of tuples available for processing by the first operator;
processing, at the first operator, at least a first set of the plurality of tuples according to a first type of priority; and
upon detecting, by the first operator, that a set of conditions associated with processing the plurality of tuples are satisfied, processing, at the first operator, at least a second set of the plurality of tuples according to a second type of priority.

18. The computer program product of claim 17, wherein processing the first set of the plurality of tuples comprises:
transmitting, according to the first type of priority, a first tuple of the first set of the plurality of tuples to a second operator; and
after transmitting the first tuple, transmitting, according to the first type of priority, a second tuple of the first set of the plurality of tuples to the second operator.

19. The computer program product of claim 17, wherein processing the second set of the plurality of tuples comprises:
transmitting, according to the second type of priority, a first tuple of the second set of the plurality of tuples to a second operator; and
after transmitting the first tuple, transmitting, according to the second type of priority, a second tuple of the second set of the plurality of tuples to the second operator.

20. The computer program product of claim 17, the operation further comprising:
identifying, by the first operator, a first tuple of the plurality of tuples having a first priority level;
determining, by the first operator, a first amount of time that the first tuple has been waiting to be processed at the first priority level by the first operator; and
upon determining that the first amount of time satisfies a threshold amount of time associated with the first priority level, increasing, by the first operator, the priority of the first tuple to a second priority level.
